(19) United States
(12) Patent Application Publication
(10) Pub. No.: US 2016/0109333 A1
(43) Pub. Date: Apr. 21, 2016

(54) PRESSURE-DROP DEVICE

(71) Applicants: BAYER TECHNOLOGY SERVICES GMBH, Leverkusen (DE); KROHNE MESSTECHNIK GMBH, Duisberg (DE)

(72) Inventors: Régulo Miguel Ramírez Wong, Hamburg (DE); Jörg Müller, Hamburg (DE)

(73) Assignees: KROHNE MESSTECHNIK GMBH, Duisberg (DE); BAYER TECHNOLOGY SERVICES GMBH, Leverkusen (DE)

(21) Appl. No.: 14/878,380

(22) Filed: Oct. 8, 2015

(30) Foreign Application Priority Data
Oct. 21, 2014 (DE) 10 2014 221 370.3

(51) Int. Cl. G01N 1/00; H01J 49/04; G01N 30/00

(52) U.S. Cl. CPC G01N 1/00; G01N 30/00; H01J 49/0404; G01N 2001/002

(57) ABSTRACT

Pressure-drop device, useful for gas chromatographs or mass spectrometers, containing a planar base plate, a cover plate, a gas inlet opening, and a gas outlet opening, which are connected by a capillary groove, wherein the capillary groove is embodied as an etched groove or pressed groove in the base plate and covered by the cover plate and wherein a plurality of pressure-drop devices can be connected to form a module.

The invention relates to a pressure-drop device, as can be used, in particular, as a component of gas chromatographs or mass spectrometers but also as a component of a reducing valve.

### BACKGROUND OF THE INVENTION

For chemical analysis, use is made of techniques such as mass spectrometry or gas chromatography, in which the constituents of a sample are separated according to different physical principles. Thus, in gas chromatography, the constituents of the sample are separated spatially on the basis of the diffusion time of the molecules through a separation column. In mass spectrometry, individual molecules are ionized and separated temporally according to the mass-to-charge ratio thereof. In both cases, the injection system plays an important role since the pressure prevalent therein substantially influences the measurement and the design of the measuring apparatuses.

The samples are generally at atmospheric or positive pressure. A very much lower pressure is required for the operation of a mass spectrometer. Many mass spectrometers are operated at pressures of less than 0.1 Pa, and so a pressure-drop stage is required. The latter is usually implemented by capillaries of a defined length and with a constant cross-sectional dimension, which reduce the pressure by the flow resistance thereof. Such capillaries can be up to several metres in length and the resultant time-of-flight of the sample can be a few minutes as a result thereof. Alternatively, use is made of mass flow regulators, by means of which the pressure can be set and regulated. As a result of these devices, both the complexity at the periphery of the injection system and the dead volume and the response time are significantly increased. In the case of liquid samples, these additionally have to initially be brought into the vapour phase. In this case, it is particularly important to prevent re-condensation of the vapour in the pressure reduction path. The aforementioned injection systems with the voluminous extent must therefore be heated using complicated processes, for the purposes of which use can be made of e.g. meandering heating elements. These measures substantially increase the operating complexity, the energy consumption and the volume of the injection systems and require very voluminous thermal shielding.

Against the backdrop of this prior art, the inventors have set themselves the challenge of developing a miniaturized pressure-drop device, which is suitable for reducing pressure within a very small space, into which the evaporator unit of, in particular, a mass spectrometer or a gas chromatograph can be integrated, which is cost-effective in the production thereof, which can easily be replaced and which avoids direct condensation during work conditions by dropping below the vapour pressure of the sample.

### SUMMARY OF THE INVENTION

This object is achieved by the provision of a pressure-drop device, containing a planar base plate and a cover plate, and a gas inlet opening and a gas outlet, which are connected by way of a capillary groove, wherein the capillary groove is embodied as an etched groove or pressed groove in the base plate and covered by the cover plate.

The capillary groove is closed off to form a capillary channel by placing the cover plate onto the base plate.

In a general embodiment, the invention proposes the use of a capillary groove, as pressure-drop device, for connecting an opening for the gas inlet to an opening for the gas outlet rather than a capillary, which capillary groove is etched into a base plate and covered by a cover plate.

### DETAILED DESCRIPTION

In order to produce such a pressure-drop device, a person skilled in the art initially proceeds from the base plate. The base plate is preferably made of an anisotropically etchable material. Silicon, but also other semiconductor materials, is particularly suitable here. Such materials are known to a person skilled in the art of microsystems technology. The dimensions of the base plate can be selected as desired. They conform primarily to the circumstances of the apparatus, to which the pressure-drop device is to be connected.

According to the invention, all that is required is a planar surface, into which the capillary groove can be introduced. This is preferably brought about by etching. However, it is also possible to impress the groove into thermoplastic materials.

A person skilled in the art also has freedoms when determining the geometry of the capillary groove. The groove can be embodied with a spiral shape, with a meandering shape, in the form of a sinusoidal curve or in an other geometric form. The only precondition is that it connects an opening for the gas inlet with an opening for the gas outlet. Here, these openings can be embodied individually or together in the base plate, or one or both can be situated in the cover plate.

The following relationships apply to the length and cross-sectional dimension of the capillary groove: the pressure drop increases with increasing length of the groove and decreases with increasing cross section of the groove, with both relationships being nonlinear. The precisely required length and the precisely required cross-sectional dimension for a specific system are also dependent on the amount and type of gas, which is intended to be treated in the pressure-drop device.

The following values can apply as rough indications: lengths of the respective stages of approximately 5 mm to approximately 50 mm with cross-sectional dimensions of approximately 10 μm to approximately 200 μm have proven their worth for a mass spectrometer which operates at a pressure of less than 0.1 Pa.

Lengths from approximately 5 millimetres to approximately 20 millimetres in the case of cross-sectional dimensions of approximately 20 μm to approximately 60 μm for the input stage and lengths from 3 mm to 10 mm in the case of cross-sectional dimensions of 100 μm to 200 μm have proven their worth for a gas chromatograph which operates at a pressure of less than 10 Pa.

The capillary groove can have a constant cross section or an increasing cross section. However, the capillary groove preferably has a constant cross section or a cross section widening in steps from the entry to the exit.

The cross-sectional form of the capillary grooves is arbitrary, but it is usually semicircular or rectangular for the purposes of a simple production by etching.

For the purposes of covering the capillary grooves etched or impressed into the base plate, use is made of a cover plate. By way of example, suitable cover plates are made out of glasses, in particular borosilicate glass. A person skilled in the art can also select or modify the dimensions of the cover plate within broad boundaries and therefore match these to the circumstances of the measuring apparatus to be connected.

A person skilled in the art can also freely select the thickness of the base plate and cover plate. In practice, thicknesses of between 200 μm and 500 μm have proven their worth.

The etching methods for producing the base plate are known to a person skilled in the art of microsystems technology. Conventionally, the following process is undertaken: the base plate, i.e., for example, a body made of silicon, is polished to be flat and then the grooves in the form of a semicircle, a V-structure or with a rectangular cross-section, defined by a mask implemented by photolithography, are etched by a wet chemical, generally isotropic, etching method, preferably by an anisotropic plasma-assisted dry etching method for keeping a higher structure fidelity.

The cover plate is applied onto the base plate. The method of anodic bonding, known from microsystems technology, is particularly suitable to this end. To this end, the glass substrate and silicon substrate are pressed onto one another and chemically connected at temperatures between 200° C. and 400° C. and with an applied electric DC voltage of several 100 V, with the negative pole on the glass side, this is caused by the migration of sodium ions in the glass away from the interface to the silicon and the chemical binding of the remaining oxygen with the silicon.

In order to increase the field of application of the pressure-drop device, the invention proposes implementing this by regulating the temperature. Since the pressure in the system increases proportionally with temperature in the case of constant volume and the viscosity of the gas, and therefore the flow resistance, increases with the square root of the gas temperature, the amount of gas available at the exit, and therefore the pressure thereof, falls greater than proportionally with temperature. According to a particularly preferred embodiment of the invention, provision is therefore made of providing a heating element, preferably on the side of the base plate, optionally also on the side of the cover plate, due to the high thermal conductivity of semiconductors. Films or plates, which are heated electrically or by a heating fluid and which transmit the heat by thermal conduction, are suitable as heating elements. However, radiation sources, such as e.g. infrared lamps, are also suitable. The heating face is preferably regulable such that a specific temperature or a specific temperature range can be set.

The pressure-drop device according to the invention has a gas inlet and a gas outlet. A person skilled in the art can match the gas inlet opening and the gas outlet opening within large boundaries to the requirements of the apparatuses to be connected. By way of example, use can be made of connectors as used in the gas chromatograph or mass spectrometer according to the prior art for connecting the capillaries used there. The inlet opening and the gas outlet opening can be applied to the side of the base plate or to the side of the cover plate. However, it is preferable to apply both openings on the side of the base plate or of the cover plate. However, for example, the gas inlet opening can also be formed on the side of the base plate, the gas outlet opening on the side of the cover plate, or vice versa.

According to a preferred embodiment of the invention, the gas outlet opening (4) is embodied as a cavity. The cavity can serve to hold a connection or connector element of a mass spectrometer or else the inlet of the separation column of a gas chromatograph. Here, an advantage of the pressure-drop device according to the invention is that the geometry can be adapted particularly easily due to the production by the etching method.

According to a further preferred embodiment of the invention, the capillary groove widens in front of the cavity in order to ensure a more reliable connection.

According to a further embodiment of the invention, the base plate can be provided with a capillary groove by etching on the front side and the rear side, and both sides can be covered by a cover plate, with the two grooves being connected by a bore.

Due to the requirement of reducing the pressure by orders of magnitude, it is advantageous to connect a plurality of capillary grooves with increasing cross section in series rather than have a single capillary groove, and thus extend the steep pressure drop at the end of each of the individual structures to relatively long paths in the subsequent structure and thus ensure high accuracy in relation to the desired output pressure. To this end, a plurality of pressure-drop devices with a constant cross section and with a gas inlet and a gas outlet adapted to one another can be connected in series to one another in a pressure-drop module.

In order to simplify the set up, particularly in the case of known pressure and flow conditions, and in order to avoid dead volumes completely, it is also possible to produce the capillary grooves with different cross sections directly on a substrate. Here, the cross-sectional dimension of the grooves preferably increases toward the gas outlet.

According to a further preferred embodiment of the invention, a plurality of pressure-drop devices are connected to form a module.

Modules according to the invention can be produced from the pressure-drop devices by stacking base plate, cover plate, base plate, cover plate and so forth, on one another or by stacking a plurality of base plates on one another, followed at the end by a cover plate.

According to a preferred embodiment, a module consists either of 2 to 10 pairs of base plate/cover plate or of at least one cover plate and up to 10 base plates and it is embodied in such a way that the plates are layered above one another in a sandwich-type manner and the capillary grooves form a continuous channel from the inlet opening of the first plate to the outlet opening of the last plate.

Preferably, modules made of pressure-drop devices only contain one cavity at the gas outlet opening of the module, but where possible no cavities, at best a broadening of the capillary channel, at the gas outlet of each individual pressure-drop device. Thus, by combining a plurality of pressure-drop devices with increasing cross sections from the entrance to the exit, a system can be produced in a simple manner which enables the setting of a pressure drop under very different method conditions. In general, 2-5 pressure-drop devices are combined together in a module. The connection between gas exit and gas inlet of the next module can be brought about by mechanical connection methods, such as screwing or adhesive bonding. Within a module, it is preferable to stack the devices one above the other. In the case of entrance and exit openings lying above one another with an exact fit, anodic bonding can then also be used for connecting the devices. According to a preferred embodiment, the devices are stacked on one another in such a way that the gas outlet of one device overlaps with the gas inlet of the next device.

When producing the pressure-drop device and/or the modules, a person skilled in the art will take care to avoid dead volumes as far as possible.

A further subject matter of the invention relates to a gas chromatograph, containing at least one pressure-drop device according to the invention. Here, the pressure-drop device is situated at the position at which, otherwise, the capillaries required for the pressure drop are installed, i.e. between the sample inlet and the separation column. Preferably, it is connected flush to the inlet of the separation column. According to a particularly preferred embodiment, it is connected to a heating plate such that it can be subjected to temperature control. According to a further preferred embodiment, it is connected so closely to the separation column that it can be operated at the temperature of the separation column and so that there is no need for separate heating of the pressure-drop device.

A further subject matter of the invention relates to a mass spectrometer, containing one or more pressure-drop devices according to the invention. Here too, said pressure-drop device or devices is/are installed between the sample inlet chamber and the actual mass spectrometer or directly integrated into the system.

The advantages of the pressure-drop device according to the invention lie in the fact that the pressure-drop stage can operate virtually without additional energy requirements as a result of the small thermal mass and the small volume. The pressure-drop stage lying at approximately the evaporator temperature enables the reduction in the sample pressure at this temperature. The sample pressure can be reduced in the pressure-drop stage to below the vapour pressure of the sample gas at room temperature such that condensation no longer occurs when the sample leaves the heated region of the evaporator. At the same time, the exit pressure of the sample in the pressure region of the subsequent analysis system, e.g. of a mass spectrometer or a gas chromatograph, can be set.

The cost-effective production of the pressure-drop device and the simple integration into the sampling system enables an economic replacement in the case of a blockage or in the case of failure of the system. The micro-pressure-drop unit can also easily be adapted to very different sample liquids and required pressure differences and flows.

A further subject matter of the invention relates to a gas chromatograph/mass spectrometer (GC/MS) coupling containing 1 to 2 pressure-drop device(s), namely an optional pressure-drop device between sample inlet and gas chromatograph, and a pressure-drop device between the exit of the gas chromatograph and the mass spectrometer.

A further subject matter of the invention relates to a reducing valve, containing one or more pressure-drop devices according to the invention as a component in the gas flow.

The invention will be explained in more detail on the basis of the drawings.

### BRIEF DESCRIPTION OF THE DRAWINGS

In FIG. 1, (1) denotes the base plate. The cover plate (2) is attached to the base plate. The base plate contains the gas inlet opening (3), while the cover plate contains the gas outlet opening (4).

FIG. 2 depicts the capillary groove. In this case, a meandering capillary groove is selected.

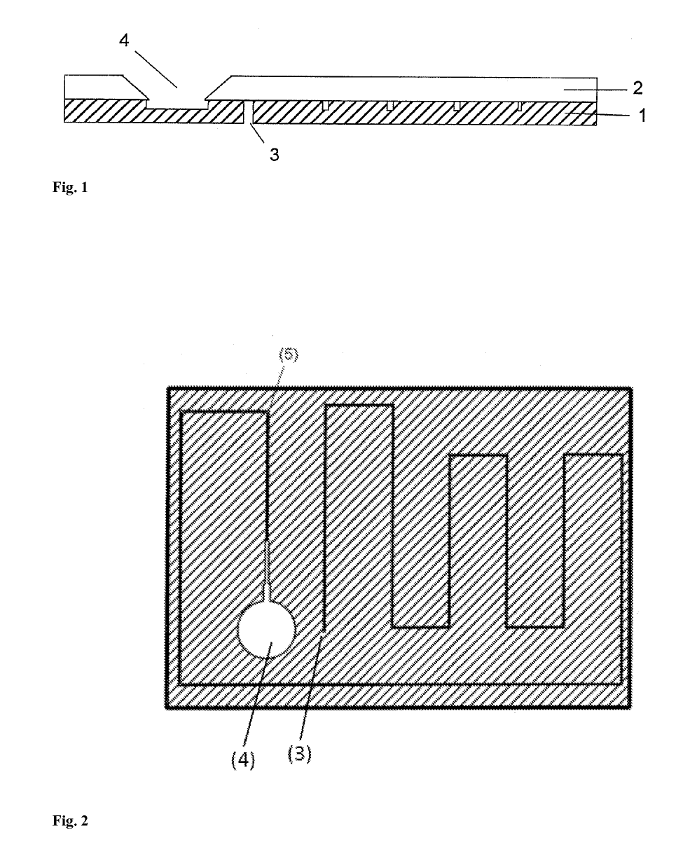

FIG. 3 shows the sampling system of a mass spectrometer (6), comprising a recess for holding a pressure-drop device (9) according to the invention with a fitting entry and exit opening (not depicted here). The pressure-drop device (7) according to the invention is inserted into this recess as component such that the entry and exit openings of the sampling system are connected to the gas inlet and gas outlet of the pressure-drop device and fastened by a cover (8).

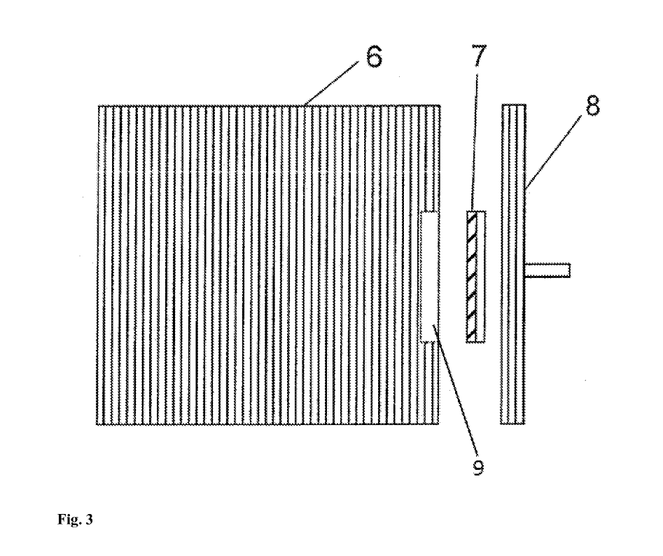

Usually, the fastening is implemented with the aid of a locally perforated film or O-ring seal (not depicted here) preferably with good thermal conductivity. Furthermore, the cover (8) has an integrated heating element.

1. Pressure-drop device, containing a planar base plate, a cover plate, and a gas inlet opening and a gas outlet, which are connected by way of a capillary groove, wherein the capillary groove is embodied as an etched groove or pressed groove in the base plate and covered by the cover plate.

2. Pressure-drop device according to claim 1, wherein a heating element is present, connected adjacently, as a further plate on the side of the base plate or on the side of the cover plate.

3. Pressure-drop device according to claim 1, wherein the base plate consists of of silicon or a semiconductor material.

4. Pressure-drop device according to claim 1, wherein the cover plate consists of a borosilicate glass.

5. Pressure-drop device according to claim 1, wherein the gas inlet opening and the gas outlet opening are both embodied on the same or on the opposite plane of the base plate.

6. Pressure-drop device according to claim 1, wherein the gas inlet is embodied on the free side of the base plate and the gas outlet is embodied on the free side of the cover plate.

7. Module made of pressure-drop devices, made from at least 2 to at most 10 pressure-drop devices according to claim 1 connected in series, wherein the module is constructed either from 2 to 10 pairs of base plate/cover plate or from at least one cover plate and up to 10 base plates in such a way that the plates are layered above one another in a sandwich-type manner and the capillary grooves form a continuous channel from the inlet opening of the first plate to the outlet opening of the last plate.

8. Gas chromatograph, containing at least one pressure-drop device according to claim 1.

9. Mass spectrometer, containing at least one pressure-drop device according to claim 1.

10. Reducing valve, containing at least one pressure-drop device according to claim 1.
